(19) United States
(12) Patent Application Publication
(10) Pub. No.: US 2005/0265263 A1
(43) Pub. Date: Dec. 1, 2005

(54) Method of providing resources with restricted access

(75) Inventor: Wieslawa Wajda, Keltern (DE)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/122,070

(22) Filed: May 5, 2005

(30) Foreign Application Priority Data
May 11, 2004 (EP) 04291205.5

(51) Int. Cl. H04L 12/16

(52) U.S. Cl. 370/259

(57) ABSTRACT

The present invention relates to a method of providing within an IP network (1) resources (51 to 58) with restricted access and an access server (21 to 27) to execute this method. A user logs on an access server (23) via the IP network (1). The access server (23) stores data about at least one released application server (51), wherein the data about the at least one released application server comprises contact data for the internet service provider providing the application server's access to the IP network (1) and authentication data necessary to request the internet service provider to grant the application server (51) access to the IP network (1). The access server (23) establishes a connection to the IP network (1) between the access server (23) and a network access server (31) of the internet service provider specified by means of said contact data. Then, the access server requests said network access server (31) by means of said authentication data to connect the application server (51) with the IP network (1), allocate an IP address to the application server (51) and relay data between the application server (51) and the access server (23).

### TECHNICAL FIELD

The present invention relates to an access server and a method for providing within an IP network resources with restricted access.

The invention is based on a priority application, EP 04291205.5, which is hereby incorporated by reference.

### BACKGROUND OF THE INVENTION

To maintain safety and privacy of information is of growing importance within today's telecommunication networks. Concepts as virtual private networks, authentication authorization services and tunneling protocols are developed to ensure safety and privacy of information.

For example, WO 03/060718 describes a system based on an application server, an authentication authorization server and an internet browser. A certificate and authentication session cookie can be stored on the client machine. Client, application server, and authentication authorization server form an interacting computer network. A database stores information specific to the applications. Components of the authentication authorization server encapsulates services available to applications and application servers. Two types of services are available: authorization services and user data services. Authorization services may be used by an application to query for authorization rights for a specific user regarding a specific resource. User data services may be used by an application to query for information about a user. An authentication module maintains data pertinent to the user's registration with the system. Account manager allows users to manage their permits. Thereby, it becomes possible to delegate permissions to access an application to a second user. Upon authenticating of the second user, the second user is provided with access to the application.

But such approaches are based on a static release of an application server within the internet and a static configuration of the domain name servers and the routing tables. Further, such methods restrict the access to the application servers by means of protection mechanisms executed by the application servers themselves. This complicates a dynamic temporary resource deployment in the internet.

It is the object of the present invention to provide dynamically internet resources with restricted access.

The object of the present invention is achieved by a method of providing within an IP network resources with restricted access, wherein the method comprises the steps of: logging on an access server via the IP network, the access server storing data about at least one released application server and the data about the at least one released application server comprising contact data of the internet service provider providing the application server's access to the IP network and authentication data necessary to request the internet service provider to grant the application server access to the IP network; establishing a connection through the IP network between the access server and a network access server of the internet service provider specified by means of said contact data; and requesting, by the access server, said network access server of the internet service provider by means of said authentication data to connect the application server with the IP network, allocate an IP address to the application server and relay data between the application server and the access server (IP=Internet Protocol).

The object of the present invention is further achieved by an access server for providing within an IP network resources with restricted access, wherein the access server comprises a storage unit for storing data about at least one released application server, the data about the at least one released application server comprising contact data of the internet service provider providing the application server's access to the IP network and authentication data necessary to request the internet service provider to grant the application server access to the IP network; and a control unit adapted to establish a connection through the IP network between the access server and a network access server of the internet service provider specified by means of said contact data and to request said network access server by means of said authentication data to connect the application server with the IP network, allocate an IP address to the application server and relay data between the application server and the access server.

### SUMMARY OF THE INVENTION

The invention enables easy and secure temporary resource deployment within an IP network. It increases security, confidence and privacy in public IP networks. It is not longer necessary to execute and update specific security applications on a local application server to restrict access to the resources of the application server. Further, it becomes possible to apply dynamic IP address allocation schemes on application servers. Since a new IP address is assigned to the application server each time an access is granted by means of the access server, it is not possible for third parties to contact the application and try to overcome the local security mechanisms. Further, the access server triggers the connection of the application server with the IP network. Therefore, it is impossible for a third party to contact the application server via the IP network without the permission of the access server since the application server is only connected with the IP network if this is requested by the access server. Consequently, the invention enables an easy and dynamic temporary resource deployment within an IP network combined with a high level of security and privacy.

Further advantages are achieved by the embodiments of the invention indicated by the dependent claims.

Preferably, the access server establishes a secure connection through the IP network with the network access server of the internet service provider specified by means of the stored contact data. For example, the access server and the network access server use an SSL protocol for establishing such secure connection (SSL=Secure Socket Layer).

Further, a secure connection is established between the access server and the application server when the network access server of the internet service provider has connected the application server with the IP network and has allocated an IP address to the application server. Data which has to be exchanged between the application server and the access server are in the following transferred via this secure data connection. A user logs on the application server via a secure data connection established between an IP terminal of the user and the access server through the IP network. Further, the access server relays data that have to be exchanged between the application server and the IP terminal logged on the access server. Consequently, the access server provides a secure connection between the network access server transports the IP terminal and the application server that guarantees security and privacy of the data exchanged between the user and the application server. Further, the network access server transfers the IP address allocated to the application server via a secure connection to the access server which keeps this address secret. Neither the access server nor the network access server transfer this information to the user terminal. Therefore, the IP address allocated to the application server is kept in secure environment which further improves the security of the system. It is not possible for a third party to spy out this IP address by monitoring IP data flows or spy out the IP terminal of the user.

Preferably, the access server stores data about a plurality of released application servers deploying resources within the IP network. Each of these data contain specific user authentication data used by an authorization procedure executed by the access server. When a user logs on an access server, the authorization procedure is started and checks the authorization of the accessing user to access the application server specified by the user. The user authentication data stored in the storage unit of the access server is used to perform this authorization procedure.

According to a preferred embodiment of the invention, the data about the at least one released application server further comprises a grant profile that specifies access rights on the application server in a detailed way. For example, it specifies a set of predefined users, details about their access rights and user authentication data, rights of these users to grant sub-rights to other users, access rights dependent on time and environmental conditions and so on. The access server checks the compliance with said grant profile when executing the aforementioned authorization procedure. Thereby, the access rights to various users may be perfectly shaped to security requirements and user needs.

According to a further embodiment of the invention, the access server provides a kind of network service which makes it possible to users to register their computer as application servers on the fly. A user logs on the access server and subscribes to the service provided by the access server. It registers one or several of his computers as application servers, for example when he intends to go on vacation or a business trip and intends to be still in a position to access data stored on this registered computer or computers. Then, the user transfers contact data and authorization data to the access server. These data are stored in the storage unit of the access server. After this registration process, the user is in a position to access data of the registered computer or computers via any IP terminal connected with the IP network. That makes it possible for a user to temporarily deploy resources within the IP network in a really flexible manner.

According to a preferred embodiment of the invention, a plurality of access servers are provided within the IP network. Preferably, a user or application server randomly selects the access server used for register the application server. Therefore, it is not possible for a third party to know which of these access servers has the ability to contact the application server. To access the application server, a third party has additionally to gain contact data of the access server used to register the application server. This approach results in further improvements in safety and privacy of the data stored by the application server.

The invention makes it possible to connect an application server providing resources in an IP network via a public switched telecommunication network, for example via an ISDN or DSL channel established on demand (ISDN=integrated Services Digital Network; DSL=Digital Subscriber Line). This enables an easy and flexible temporary provisioning of resources within the IP network.

### BRIEF DESCRIPTION OF THE DRAWINGS

These as well as other features and advantages of the invention will be better appreciated by reading the following detailed description of presently preferred exemplary embodiments taken in conjunction with accompanying drawings of which:

FIG. 1 is a block diagram showing a telecommunication system with a plurality of access servers according to the invention.

FIG. 2 is a functional view of an access server according to the invention.

### DETAILED DESCRIPTION OF THE INVENTION

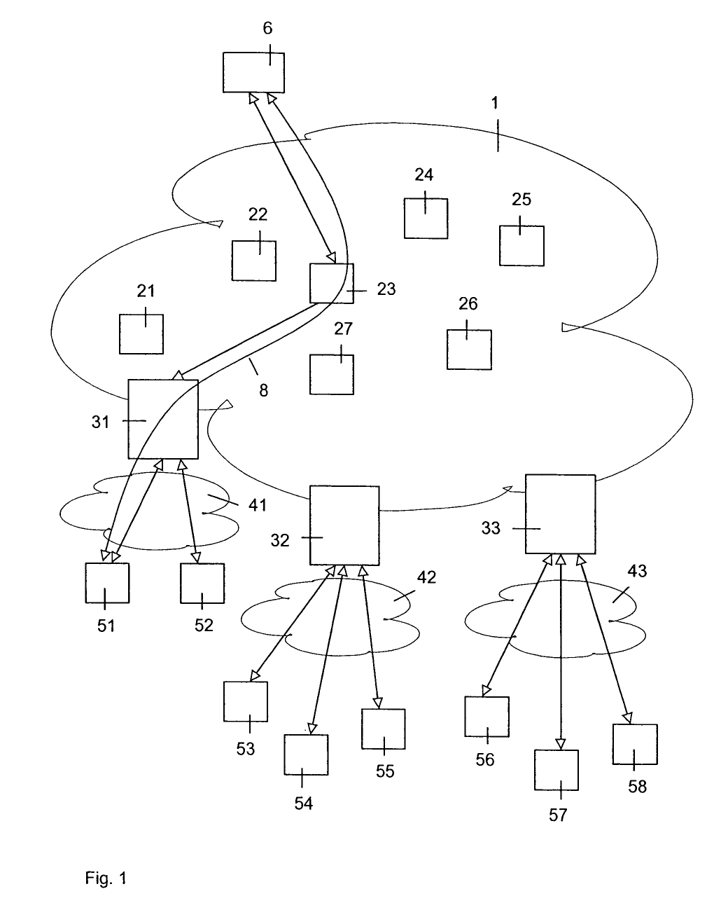

FIG. 1 shows an IP network 1, network access servers 31 to 33, access networks 41 to 43 and application servers 51 to 58.

The IP network 1 is composed of a plurality of physical interlinked communication networks using a common IP protocol as level 3 communication protocol (IP=Internet Protocol). These physical networks are, for example, ATM, MPLS, Ethernet or SDH networks (ATM=Asynchroune Transfer Mode; MPLS=Multi Protocol Label Switching; SDH=Synchrone Digital Hierarchy).

A plurality of access servers 21 to 27 are connected with the IP network 1. Each of the access servers 21 to 27 are composed of one or several interconnected computers executing a set of software programs and equipped with a communication device enabling communication through the IP network 1. The access servers 21 to 27 store data about the application servers 51 to 58, the stored data comprising contact data of the internet service provider providing the access of the respective application server to the IP network 1 and authentication data necessary to request the internet service provider to grant the respective application server's access to the IP network 1. Further, it provides functionalities to register such information and apply this information to provide resources of the application servers 51 to 58 within the IP network 1.

The application servers 51 to 58 are connected via the access networks 41 to 43 and the network access servers 31 to 33 with the IP network 1. By way of example, the application servers 51 to 52 are connected via the access network 41 and the network access server 31 with the IP network 1, the application servers 53 to 55 are connected via the access network 42 and the network access server 32 with the IP network 1 and the application servers 56 to 58 are connected via the access network 43 and the network access server 33 with the IP network 1.

The access networks 41 to 43 are, for example, one or several telephone networks, for example, PSTN networks or ISDN networks (PSTN=Public Switched Telecommunication Network; ISDN=Integrated Services Digital Network). Further, it is possible that the networks 41 to 43 are fixed or mobile telecommunication networks, for example networks according to the GSM or UMTS standard (GSM=Global System for Mobile Communication; UMTS=Universal Mobile Telecommunication System).

For example, the application servers 51 to 58 are connected via switched connections of the access networks 41 to 43 with the IP network 1. In such case, the application servers 51 to 58 use an analogue or ISDN modem to exchange data with the IP network 1. Further, it is possible that the application servers 51 to 58 are connected via DSL connections or via a cable network with the IP network 1 (DSL=Digital Subscriber Line).

Various internet service providers provide points of presence (POP) within the access networks 41 to 43. The points of presence enable their subscribers to access the IP network 1. For example, an internet service provider provides one or several points of presence within each region of a telephone network. Their subscribers access the points of presence via the telephone network to exchange data with the IP network 1. A point of presence consists of one or more network access servers, for example of the network access servers 31. The network access servers 31 check the authorization of a user contacting the point of presence. It checks the authorization of this user to access the IP network 1 via the service provided by the internet service provider operating this point of presence. Authorization data are exchanged between the application server that requests access to the IP network 1 and the respective network access server of the contacted point of presence. If the check is positive, the network access server 31 allocates an IP address to this application server and relays the data flow between the IP network 1 and the application server.

Further, the network access server 31 provides an interface to be contacted via the IP network 1 to perform such kind of authorization process and connects a selected one of the application servers 51 to 58 with the IP network 1, if the authorization is positive.

The application servers 51 to 58 are computers equipped with a communication card to communicate via the access networks 41 to 43.

To make the resources of his computer available within the IP network 1, a user selects one of the access servers 21 to 26, logs on the selected access server via the IP network 1 and registers the computer within the selected access server as application server. For example, a user triggers the establishment of a secure connection between the application server 51 and the access server 23 via the access network 41 and the IP network 1. Then, data about the application server 51 comprising contact data of the internet service provider providing the access of the application server 51 to the IP network 1 and authentication data necessary to request this internet service provider to grant the application server 51 access to the IP network 1 are transferred within the registration process from the application server 51 to the access server 23.

Further, it is possible that the user logs on the selected access server by any IP terminal connected to the IP network 1 to register the application server 51. It is not necessary to execute the registration process by means of the application server that has to be registered.

Preferably, the application server 51 randomly selects one of the access servers 21 to 27 from a list of available access servers and in the following contacts this randomly selected access server for starting the registration process. Further, it is possible to provide within the IP network 1 a broker which performs a random selection process and replies to the accessing terminal the contact address of the randomly selected access server. Such random selection of the access server out of a group of available access servers additionally improves the security of the system.

If the user intends to remotely access resources of the application server 51 via the IP network 1, it contacts the access server 23. For example, the user contacts the access server 23 via an IP terminal 6, logs on the application server 23 and requests access to the application server 51. The access server 23 executes an authorization procedure checking the right of the user to access the application server 51. Then, it establishes a connection through the IP network 1 to a network access server of the internet service provider specified by means of the contact data registered for the access server 51. For example, the access server 23 establishes a connection with the network access server 31. Then, the access server 23 requests the network access server 31 by means of the authentication data registered for the application server 51 to connect the application server 51 with the IP network 1, allocate an IP address to the application server 51 and relay data between the application server and the access server 23. If the result of the authorization procedure is positive, the network access server 31 triggers the establishment of a communication connection between the application server 51 and the network access server 31 through the access network 41. Then, it allocates an IP address to the application server 51 and transfers the allocated IP address to the access server 23. In the following, data are exchanged between the access server 23 and the application server 51 in a bi-directional way, wherein the exchanged data are relayed by the network access server 31. Further, the access server 23 relays data that has to be exchanged between the IP terminal 6 and the application server 51 and thereby provides an end-to-end communication connection 8 between the IP terminal 6 and the application server 51.

If the IP terminal 6 releases the end-to-end connection 8 or requests the access server 23 to release the end-to-end connection 8, the access server 23 requests the network access server 31 to release its connection with the application server 51, whereupon the network access server 31 interrupts the connection between the application server 51 and the IP network 1.

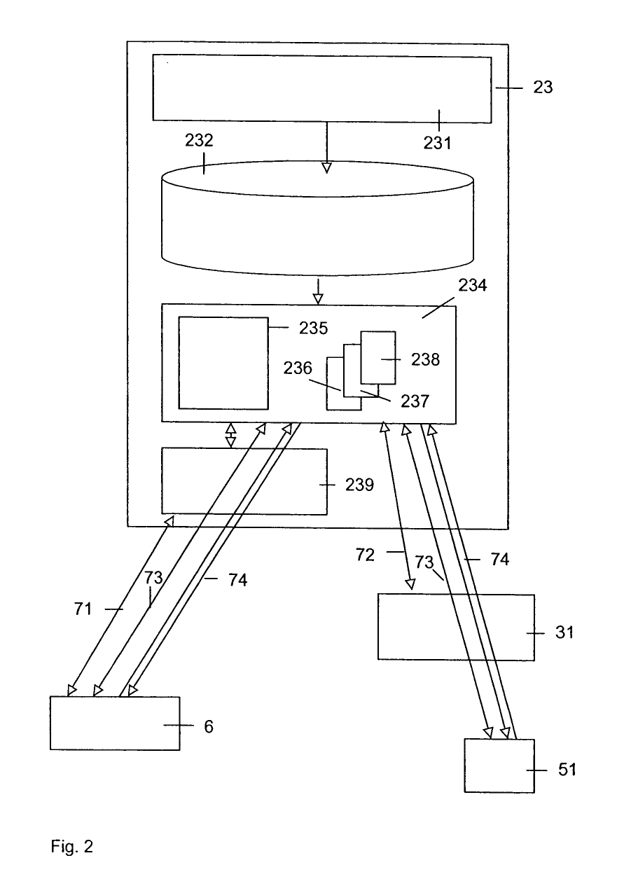

In the following, a detailed implementation of a further embodiment of the access server 23 is exemplified by means of FIG. 2.

FIG. 2 shows the access server 23, the IP terminal 6, the network access server 31 and the application server 51.

The access server 23 is formed by a hardware platform and several software applications executed based on this hardware platform. The functionalities of the access server 23 are performed by the execution of these application programs by the hardware platform of the access server 23. From functional point of view, the access server 23 comprises a storage unit 232, two control units 231 and 234 and a communication unit 239.

The storage unit 232 stores data about a plurality of application servers registered in the access server 23. For each of these access servers, the storage unit 232 stores user authentication data, grant profile data and internet service provider contact and authentication data.

The user authentication data include, for example, a user name and a password selected by the user or administrator for the access to the respective application server. Further, it is possible to store an encryption key used to decrypt a random number encrypted by an accessing terminal to check the authentication of this terminal.

The contact data of the internet service provider specifies one or several network access servers of an internet service provider providing the access of the respective application server to the IP network 1. Each of the internet service providers supporting this kind of service provides at least one network access server that supports the method according to the invention. For example, the storage unit 232 stores an IP address of an access interface of this access network server provided for the interaction with the access servers 21 to 27.

The authentication data includes data necessary to request the internet service provider to grant the application server's access to the IP network 1. These data include information about the identity or address of the application server, the subscription of the user of the application server and authentication data, for example a password or an encryption key assigned to the subscription.

The grant profile specifies the user or user groups entitled to access the respective application server. It is possible that different user authentication data are assigned to different users and/or user groups. Further, the grant profile optionally specifies details of the access rights granted to the different users or user profiles. Further, it optionally comprises time and/or environmental conditions linked to the different users, user groups or access rights. For example, the access right of a specific user or user group is limited to a specific time period, to a specific location of the user or to a specific IP terminal or IP address used to contact the access server 23. Access rights may limit the access of a user or user group to a specific resources and/or data of the respective application server or to the kind of access to these resources and/or data, for example limit the access to read specific parts of the file system of the application server 51.

The control unit 231 administrates the data stored in the storage unit 232. It provides functionalities to enroll an application server and create a dedicated registration within the storage unit 232, and to delete and amend such registrations in the storage unit 232. Further, the control unit 231 provides an access interface to these functionalities enabling users to create, delete and amend registrations within the storage unit 232. Preferably, this access interface is based on WEB technology enabling a user to access the registration service by means of a WEB browser.

The control unit 234 is formed by a controller 235 and one or more relay processes 236 to 238. Further, the control unit 234 interacts with the communication unit 239 providing an access interface to IP terminals requesting to access resources of an application server registered in the storage unit 232 of the access server 23. For example, the communication unit 239 provides a WEB based interface accessible by a WEB browser.

The IP terminal 6 contacts the access server 23 via the access interface of the communication unit 239 to request access to a specific application server. Further, the IP terminal 6 transmits identification and/or user data and authentication data to the access server 23. The controller 235 checks whether the application server specified within the request is registered within the storage unit 232. Further, it executes an authentication procedure checking the authenticity of the accessing user and/or IP terminal. This authentication procedure is done by help of the user authentication data stored for the respective application server specified within the request. Further, the controller 235 checks whether the conditions of the grant profile are fulfilled for the authentified user. If the identified access server is not registered within the storage unit 232, if the result of the authentication process is not positive or if the conditions of the grant profile are not fulfilled, the controller 235 denies the further execution of the request.

Otherwise, the controller 235 establishes a secure connection with the network access server specified by the contact data of the registration. Then, it requests this network access server, for example the network access server 31, to connect the application server with the IP network 1. In the following, an authentication procedure is executed between the controller 235 and the network access server 31 wherein the controller 235 uses the authentication data stored in the storage unit 232 for the specified access server to authorize the request. When receiving the IP address allocated by the network access server 31 to the application server, for example to the application server 51, the controller establishes a secure communication connection with the application server 51 through the IP network 1 and creates a relay process, for example the relay process 236, to relay data between the IP terminal 6 and the application server 51. Preferably, the controller 236 establishes a secure connection 71 between the IP terminal 6 and the access server 23 through the IP network 1 which is in the following used to exchange the data relayed by the relay process 236.

Further, the relay process 236 monitors the data exchanged between the IP terminal 6 and the application server 51 and checks the compliance with the grant profile. If it detects an access to resources of the access server which contradicts the access rights specified in the grant profile, it denies the relay of this request. Further, it is possible that the resources of the application server 51 are in addition protected by a local protection mechanism and the user has to perform an additional authentication process to finally access resources of the application server 51. For example, data assigned to a communication 73 exchanged between the IP terminal 6 and the application server 51 via the relay process 236 which ensures such a final end-to-end authentication between the user of the IP terminal 6 and the application server 51. In the following, the IP terminal 6 is in a position to access the resources of the application server 51 based on an exchange of data 71 relayed by the relay process 236.

1. A method of providing within an IP network resources with restricted access, the method comprising the steps of:
logging on an access server via the IP network, the access server storing data about at least one released application server, wherein the data about the at least one released application server comprises contact data of the internet service provider providing the application server's access to the IP network and authentication data necessary to request the internet service provider to grant the application server access to the IP network;
establishing a connection through the IP network between the access server and a network access server of the internet service provider specified by means of said contact data; and
requesting, by the access server, that network access server by means of said authentication data to connect the application server with the IP network, allocate an IP address to the application server and relay data between the application server and the access server.

2. The method of claim 1, wherein the method comprises the further step of establishing a secure connection between the access server and the application server and transferring data exchanged with the application server via said secure connection.

3. The method of claim 1, wherein the method comprises the further step of relaying, by the access server, data that have to be exchanged between the application server and an IP terminal logged on the access server.

4. The method of claim 1, wherein a user logs on the application server via a secure data connection established between an IP terminal of the user and the access server through the IP network.

5. The method of claim 1, wherein the method comprises the further step of executing, by the access server, an authorization procedure checking the authorization of an accessing user to access an application server specified by the user.

6. The method of claim 5, wherein the data about the at least one released application server comprises a grant profile specifying access rights on the application server and the access server checks the compliance with said grant profile when executing the authorization procedure.

7. The method of claim 1, wherein the network access server connects the application server via an ISDN or DSL connection with the IP network.

8. The method of claim 1, wherein a user logs on the access server via the IP network to register his computer as application server.

9. The method of claim 1, wherein the method comprises the further steps of providing a plurality of access servers within the IP network and randomly selecting the access server used to register said application server.

10. An access server for providing within an IP network resources with restricted access, the access server comprising a storage unit for storing data about at least one released application server, wherein the data about the at least one released application server comprise contact data of the internet service provider providing the application server's access to the IP network and authentication data necessary to request the internet service provider to grant the application server access to the IP network; and a control unit for establishing a connection through the IP network between the access server and a network access server of the internet service provider specified by means of said contact data, and for requesting said network access server by means of said authentication data to connect the application server with the IP network, allocate an IP address to the application server and relay data between the application server and the access server.
